(19) United States
(12) Patent Application Publication
(10) Pub. No.: US 2017/0242881 A1
(43) Pub. Date: Aug. 24, 2017

(54) TENANT DATA MAPPING FOR MULTIPLE TENANT CLOUD APPLICATIONS

(71) Applicant: HEWLETT PACKARD ENTERPRISE DEVELOPMENT LP, Houston, TX (US)

(72) Inventors: Caio NORTHFLEET, Porto Alege (BR); Sebastien BOUAT, Genoble (FR); Luis Fernando POLLO, Houston, TX (US); Eduardo D'AVILA, Porto Alegre (BR)

(73) Assignee: HEWLETT PACKARD ENTERPRISE DEVELOPMENT LP, Houston, TX (US)

(21) Appl. No.: 15/500,042

(22) PCT Filed: Sep. 22, 2014
(86) PCT No.: PCT/US2014/056776

§ 371 Date: Jan. 28, 2017

(51) Int. Cl. G06F 17/30; H04L 29/08

(52) U.S. Cl. CPC G06F 17/30339; G06F 17/30483; G06F 17/30604; G06F 17/30566; H04L 67/1097

(57) ABSTRACT

Examples disclosed herein relate to using a tenant data mapping for multiple tenant cloud applications. For example, a processor executing tenant access instructions may retrieve data related to a tenant associated with a user login and data related to tenants with a hierarchical relationship to the tenant and create a mapping including the retrieved data. The data may be wherein data is communicated via the mapping such that cloud application instructions are related to a single tenant application

### BACKGROUND

Multi-tenant Software as a Service (“SaaS”) cloud applications may involve storing and accessing data related to multiple tenants. For example, a cloud service may be provided to multiple tenants in a manner such that the different tenants do not have access to each other's data. The tenants may be, for example, small and medium size businesses.

### BRIEF DESCRIPTION OF THE DRAWINGS

The drawings describe example embodiments. The following detailed description references the drawings, wherein:

FIG. 1 is a diagram illustrating one example of a computing system to use a tenant data mapping to communicate data for multi-tenant tenant cloud applications.

FIG. 2 is a flow chart illustrating one example of a method to create a tenant data mapping for multi-tenant cloud applications.

FIGS. 3A and 3B are diagrams illustrating one example of creating a mapping to communicate data related to tenants with a hierarchical relationship to one another.

FIG. 4 is a diagram illustrating one example of a system architecture of a multi-tenant system that communicates using a tenant data mapping.

### DETAILED DESCRIPTION

Privacy and data security are concerns for multi-tenant cloud service applications. For example, tenants may expect their data to be protected from other tenants using the cloud service. In some cases, data privacy is complicated by the fact that tenants may have a hierarchical relationship with one another where their data should be accessible to one another in some cases where the tenants are related to one another in the hierarchy. In one implementation, a computing system is a multi-tenant computing system that appears as a single tenant system to the business modules providing the cloud service. For example, there may be a separation of duties between a tenant access component and a business application component such that the tenant access component accesses tenant data and creates a mapping of the tenant data, and the business application component accesses the mapping. For example, the tenant access component may publish an interface to an Object Relational Mapping, and the business application component may access tenant data using the interface.

Separating the business logic of the cloud service application from the data store retrieval logic may also separate the data retrieval of related tenants. The data retrieved from the data store by the tenant access component may be data related to the tenant and other tenants that are to be accessible to the tenant, such as those that are children of the tenant in a hierarchy. In one implementation, the tenants whose data is retrieved depends on the particular data request, such as where some requests are related to the particular tenant and some are related to aggregated data related to tenants in the supply chain of the tenant.

Using a mapping to communicate data may increase the privacy in a multi-tenant cloud application system. For example, a malicious user attempting to attack the application to steal user information would be unable to directly access the data store, therefore, protecting the data of other tenants in the multi-tenant system. Using a mapping that creates an appearance of a single tenant system is particularly useful for systems with many users. For example, alternative approaches, such as separate tables or data models, may become unwieldy with a large number of tenants as the number of tables and/or models increases.

A system for mapping tenant data may be useful for cloud applications tailored to small and medium sized businesses. For example, a cloud application for small and medium size businesses may involve a single application to service the multiple tenants, and the number of tenants using the application may be large. Small and medium size businesses may have a supply chain that also uses the cloud application, and the related tenants in the supply chain may have access to the same set of data. For example, there may be multiple levels of tenants related to one another in a hierarchical manner, such as a retailer supplying a set of small and medium sized businesses, and a wholesaler supplying a set of retailers.

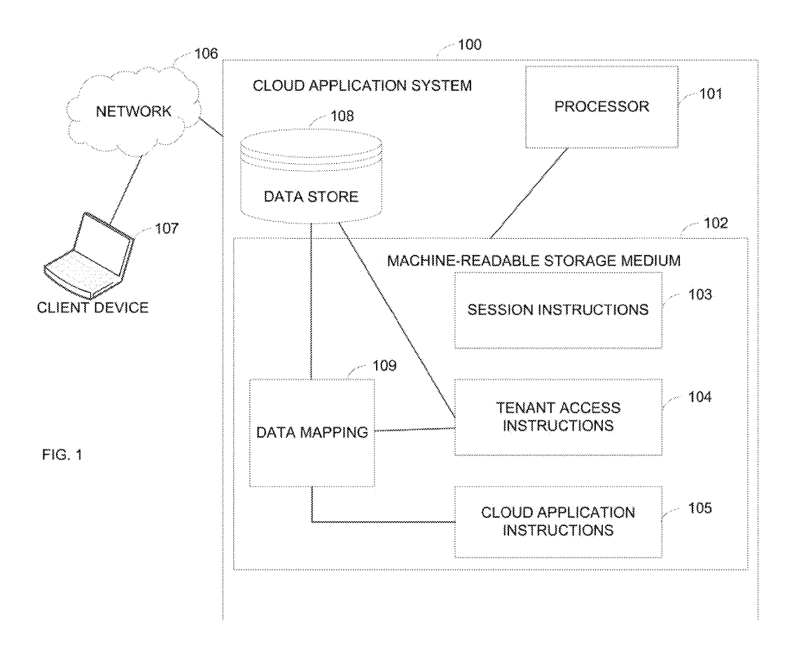

FIG. 1 is a diagram illustrating one example of a computing system to use a tenant data mapping to communicate data for multi-tenant cloud applications. The computing system may be used to create a single tenant application view in a multi-tenant cloud application system. In one implementation, the computing system may be used for tenants with a hierarchical structure, such as for small and medium sized businesses that have a hierarchical relationship with other tenants between the business and the cloud application provider. For example, a hierarchy may involve a customer business level, retailer level, and a wholesaler level, each of which has access to the cloud application. The computing system includes a client device 107, a network 106, and the cloud application system 100. The cloud application system 100 provides a cloud service to the client device 107.

The client device 107 may be any suitable device for communicating with the processor 101 via the network 106 to access a cloud application. For example, the client device 107 may be a laptop, mobile phone, or tablet computer.

The network 106 may be any suitable network for communicating between the client device 107 and the processor 101. For example, the network 106 may be the Internet.

The cloud application system 100 includes a processor 101, a machine-readable storage medium 102, and a data store 108. The data store 108 may be any suitable storage for storing data. The data store 108 may be accessible by the processor 101, such as directly or via a network. The data store 108 may be a database, such as a relational or XML database. The data store 108 may be associated with a separate device than the processor 101, such as where the data store 108 is a server that communicates with the processor 101 via a network. The data store 108 may store data related to tenants with access to the cloud application provided by the cloud application system 100.

The processor 101 may be a processor for providing a cloud application. The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium.

The machine-readable storage medium 102 includes data mapping 109. The data mapping 109 is a data mapping of data in the data store 108. The data mapping 109 may provide access to a limited portion of the data in the data store 108 such that data related to the current session tenant and tenants related to the current tenant is available. The data mapping 109 may be any suitable mapping, such as an Object Relational Mapping.

The machine-readable storage medium 102 may include instructions executable by the processor 101, such as session instructions 103, tenant access instructions 104 and the cloud application instructions 105.

The session instructions 103 may include instructions to determine a set of identifiers associated with a current session. For example, the set of identifiers may include an identifier of a tenant related to the login and of tenants with a hierarchical relationship to the tenant. In one implementation, the identifiers have a nested relationship such that the tenant identifier is determined and a range is set from the tenant identifier to indicate the children of the tenant. For example, the tenant identifier may be the number 1.3, and the range of identifiers representative of children of the tenant may be any identifiers from the number 1.3 to the number 1.4.

The tenant access instructions 104 may include instructions to handle tenant access associated with the cloud application provided by the cloud application system 100. The tenant access instructions 105 may communicate with the data store 107. The tenant access module may create the data mapping 108, and the cloud application instructions 105 may communicate with the data mapping 108. The tenant access instructions 104 may be part of a data access layer of the cloud application system 100.

The tenant access instructions 104 may access information related to a current tenant in the data store 108. The tenant access instructions 104 may receive information about an identifier associated with a tenant and/or identifiers associated with tenants related to the tenant when the session instructions 103 are executed. The tenant access instructions 104 may create the data mapping 109 and publish a data retrieval interface accessible by the cloud application instructions 105. The data mapping 109 may make available the subset of data associated with the tenant identifier of the session.

The cloud application instructions 105 may include instructions to provide a cloud service to the client device 107. For example, the tenant application module 105 may include the business logic associated with the cloud application. The cloud application instructions 105 may communicate with the data mapping 109. The cloud application instructions 105 may communicate with the data mapping 109 without the use of identifiers or other information indicating the multiple tenants of information stored in the data store 108 and without information about the hierarchical relationship between tenants indicating the additional accessible data. For example, the cloud application 105 may make data requests using the interface of the data mapping 109 to indirectly receive data from the data store 108.

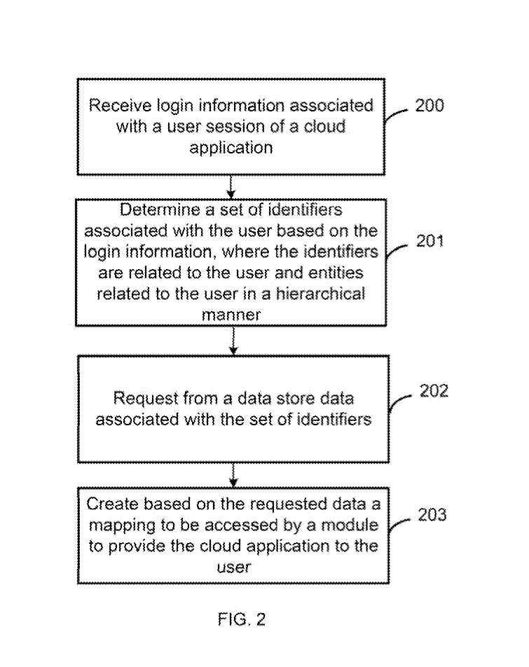

FIG. 2 is a flow chart illustrating one example of a method to create a tenant data mapping for multi-tenant cloud applications. The cloud application may be, for example, a Software as a Service (“SaaS”) application, such as an IT as a service application. The method may allow for a separation of tenant access logic from the business logic of the cloud application. The method may be implemented by the cloud application system 100 of FIG. 1. For example, the method may be implemented by the tenant access instructions 103 to create the data mapping 108 to be accessed by executing the cloud application instructions 104.

Beginning at 200, a processor, such as a processor executing the tenant access instructions 103, receives login information associated with a user session of a cloud application. The information may be received in any suitable manner. For example, a session module may receive login information from a client device, such as transmitted via a network.

In one implementation, information is stored about a tenant after an initial login. For example, the processor may create an identifier for a tenant such that the identifier reflects the relationship of the tenant to the other tenants. The identifier may ensure the login is linked to the other tenants with a hierarchical relationship to the tenant. The processor may receive information about a tenant and the hierarchical relationship of the tenant to other tenants and assign an identifier to the tenant based on the received information. The identifier may be assigned based on a nested relationship with tenants with a hierarchical relationship with the tenant, such as where a child level of a tenant is given an identifier between the identifier associated with the tenant and the next identifier associated with a tenant on the same level. A range of identifiers may be associated with a node, its children, the children's children, and so on in the hierarchy of tenants.

The identifier and relationship information may be stored in a backend data system separate from the tenant application data or in the same data store as the tenant application data. For example, a first data store may store identifier information related to a second data store associated with a tenant associated with the login. A second data store may store the information associated with the application, such as where the data store 107 of FIG. 1 includes data related to the application, and a backend data store may include data related to the login, subscriptions, and available services.

Continuing to 201, a processor, such as a processor executing the tenant access instructions 103, determines a set of identifiers associated with the user based on the login information. The identifiers may be related to the user and tenants related to the user in a hierarchical manner. The hierarchical relationship may be any tree type relationship with any number of levels. In one implementation, the processor compares the login information to information in a data store for storing administrative information associated with a cloud service, such as subscription information. In one implementation, the identifiers of related tenants are determined based on a range of identifiers associated with the tenant.

Continuing to 202, a processor, such as a processor executing the tenant access instructions 103, requests from a data store data associated with the set of identifiers. For example, the processor may request data either from the data store with the login information or another data store. The requested data may be data related to a cloud service to be provided, such as business data related to the cloud service. To retrieve data associated with the tenant, an SQL BETWEEN operator may be used to capture data related to tenants with a hierarchical relationship to the tenant where the children of a tenant are represented with identifiers within a particular range. For example, the BETWEEN operator may be used in an SQL query to find data related to identifiers between a range where the range indicates a relationship in a hierarchical tree.

Identifiers may be assigned such that a parent has an integer identifier, and the children have the same integer identifier with the first decimal place distinguishing between the children. For the next generation, the next decimal place may distinguish between the children. As an example, an identifier of a parent may be 2, and the identifier of the next tenant unrelated to the tenant may be 3. The children of the tenant may have identifiers between 2 and 3, such as 2.1 and 2.5. The children of the tenant with the identifier 2.1 may have identifiers between 2.1 and 2.2.

Any suitable database operator may be used to identify related tenants. For example, the BETWEEN operator may be used to retrieve data related identifiers between 2 and 3 such that data for the tenant with identifier 2 and the children and children's children of the tenant with identifier 2 is retrieved. In one implementation, an SQL nested set model is used which includes a left and right identifier for each tenant to represent the location of the tenant within a hierarchical tree. The left and right identifiers are set according to a traversal of the tree and may be updated to new integers when new tenants are added. In some implementations, decimal left and right identifies are used such that the identifiers are not updated with an addition. The left and right identifiers may be set sequentially down a branch as the left identifiers and continuing sequentially back up to the parent, as the right identifiers. Querying the data store to find children is a less expensive computational process that involves checking for child tenant left and right identifiers compared to the parent left and right identifiers, such as where the child left identifier is greater than the parent left identifier and the child right identifier is less than the parent right identifier.

The processor may request some data related to the individual tenant and other data related to both the tenant and tenants associated with the tenant. For example, some data may be queried based on the identifier of the particular tenant, and some data may be queried using a BETWEEN statement to retrieve data related to the tenant and tenants with a hierarchical relationship to the tenant.

Continuing to 203, a processor, such as a processor executing the tenant access instructions 103, creates based on the requested data a mapping to be accessed by a module to provide the cloud application to the user. For example, the processor may create the mapping such that it is separate from the data store and may be accessed by another module without accessing the data store. The mapping may be any suitable data mapping to allow access to the data related to the particular tenant and its associated tenants. For example, the mapping may be an Object Relational Mapping. The processor may publish an interface to the Object Relational Mapping, such that a module responsible for the business portion of the cloud application may access the data via the interface without knowledge of the multi-tenant system or the tenants associated with the tenant login. The mapping may include some data that is limited to the tenant and some that also includes other related tenants. The cloud application module may also use the mapping interface to update data to the data store.

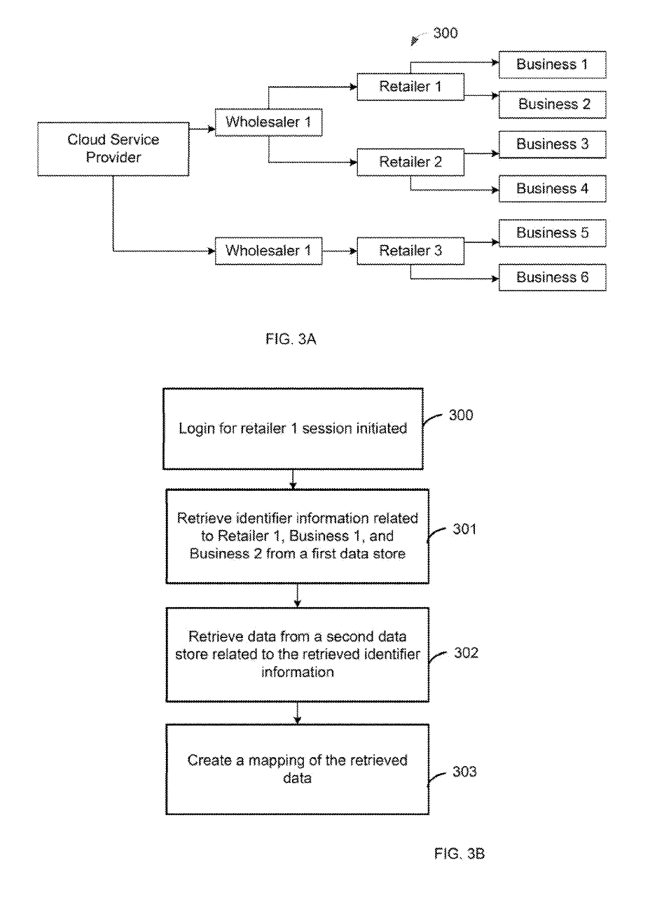

FIGS. 3A and 38 are diagrams illustrating one example of creating a mapping to communicate data related to tenants with a hierarchical relationship to one another. FIG. 3A is a diagram showing a hierarchical relationship between tenants. For example, businesses 1-6 are each associated with a retailer associated with a wholesaler associated with a cloud service provider. The businesses 1-6 may be small and medium sized businesses. A cloud application may allow retailer 1 to have access to the information available to business 1 and business 2 and for wholesaler 1 to have access to information available to retailer 1, retailer 2, business 1, business 2, business 3, and business 4.

FIG. 3B is a flow chart illustrating an example of creating a mapping of data for a login of a tenant in FIG. 3A. Beginning at 300, a user associated with retailer 1 logs in, and a session for the cloud application is initiated. Continuing to 301, a tenant access module retrieves data from a data store related to the login. The tenant access module retrieves identifier information related to retailer 1, business 1 and business 2 from a first data store. Continuing to 302, the tenant access module retrieves data from a second data store related to the retrieved identifier information. For example, the tenant access module queries a second data store for data related to the set of identifiers. Continuing to 303, the tenant access module creates a mapping of the retrieved data from the second data store. The mapping may be accessed by an application module for interfacing with the client device.

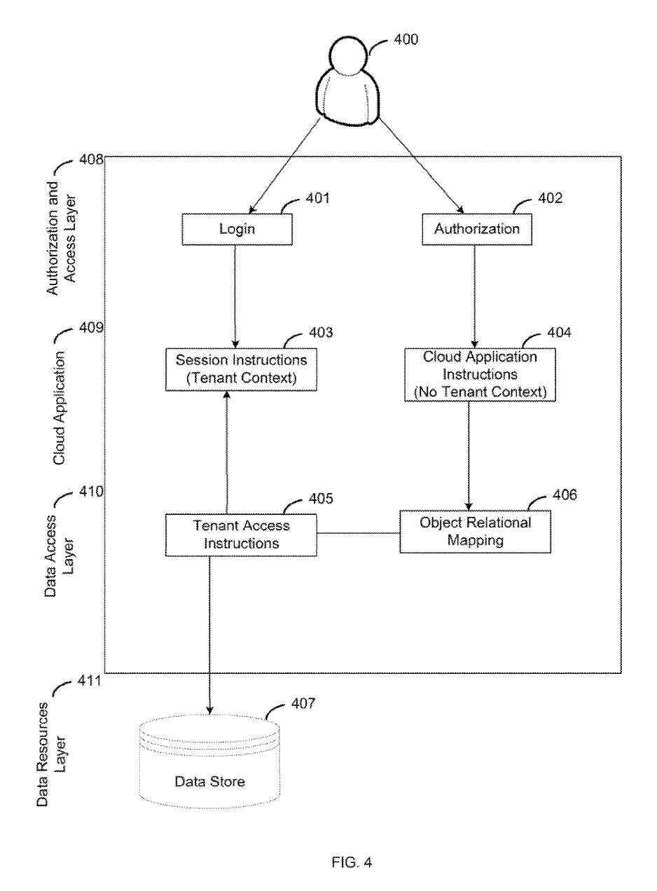

FIG. 4 is a diagram illustrating one example of a system architecture of a multi-tenant system that communicates using a tenant data mapping. For example, the tenant context of the cloud application is handled separately than the business logic associated with the service provided by the cloud application. The system architecture includes an authorization and access layer 408, a cloud authorization layer 410, a data access layer 410, and a data resources layer 411.

A user 400 accesses the cloud application via a network. The user 400 logs into the system to begin a session with the cloud application. The system architecture includes an authorization and access layer 408 to process login information and authenticate the user. The authorization and access layer 408 handles the login process, creates the session for the user, and validates that the user is authorized to perform operations with the cloud application layer 409. The authorization and access layer 408 include login module 401 and authorization module 402. For example, the login module 401 may create a user interface to receive a user login. The authorization module 402 may validate the user login and password. The login may be associated with a single tenant and/or multiple-tenants. For example, referring to FIG. 3A, a small or medium sized business may be a single tenant, but a retailer may be a hierarchical multi-tenant login to include information related to the retailer and the businesses interfacing with the retailer.

The cloud application layer 409 may have a separate session instructions 403 and cloud application instructions 404. The session instructions 403 may correspond to the session instructions 103 in FIG. 1, and the cloud application instructions 404 may correspond to the cloud application instructions 105 in FIG. 1. The session instructions 403 may involve a multi-tenant context. The session instructions 403 may be initiated at the beginning of the user login to perform administrative operations on the data prior to the cloud application running the cloud application instructions 404 to provide the cloud service to the user 400.

The data access layer 410 is responsible for the accessibility of the data resources layer 112. The data access layer 410 includes a tenant access instructions 405 and an Object Relational Mapping 406. The tenant access instructions 405 may correspond to the tenant access instructions 104 in FIG. 1. The tenant access instructions 405 may create and/or update the Object Relational Mapping 406 at any suitable time. The mapping 406 may be a single tenant object oriented interface to data that may be accessed by the cloud application instructions 404. The cloud application instructions 404 accesses the Object Relational Mapping 406 to retrieve data used to provide the cloud service such that the cloud application instructions 404 does not directly access the data resource layer 412.

The data resources layer 411 includes a data store 407. The data store 407 may allow for row level segregation between tenants, such as where each row includes an identifier associated with the tenant. The tenant access instructions 405 may set the identifier in the row for storing data and set the identifier in an SQL statement WHERE clause for retrieving data. In some implementations, the tenant access instructions 405 works with other database functionality to set and retrieve data associated with the identifier. The session instructions 403 may communicate received user login information to the data access layer 410 to the tenant access instructions 405, and the tenant access instructions 405 may use login information to create and/or retrieve an identifier associated with the login. The tenant identifier may have a nested relationship with tenant identifiers associated other tenants with a hierarchical relationship with the tenant. The tenant identifier may be used transparently to the cloud application instructions 405. For example, the identifier may be accessed by the session instructions 403, and the tenant access instructions 405 may set the identifier for any outgoing request, such as a SOAP Web API request, from the cloud application instructions 404. Separating duties between tenant access and the business logic of a cloud application using a data mapping may increase privacy in a multi-tenant cloud application environment.

1. A system, comprising:
a data storage to store information related to multiple tenants of a cloud application, wherein a subset of the tenants are related to one another in a hierarchical manner;
session instructions to:
determine identifier information associated with a current login, including an identifier of a tenant associated with the login and tenants with a hierarchical relationship to the tenant;
tenant access instructions to:
retrieve data from the data storage associated with the determined identifier information; and
create a mapping including the retrieved data; and
cloud application instructions to:
access the mapping; and
communicate, with a client device related to the current session via a network, information related to the accessed mapping; and
a processor to execute the session instructions, tenant access instructions, and the cloud application instructions.

2. The system of claim 1, wherein the tenant access module further:
receives information about a tenant and the hierarchical relationship of the tenant to other tenants;
assigns an identifier to the tenant based on the received information; and
stores information related to the assigned identifier.

3. The system of claim 2, wherein assigning the identifier comprises assigning the identifier based on a nested relationship with tenants with a hierarchical relationship with the tenant.

4. The system of claim 1, wherein the multiple tenants comprise at least one of: a customer business, a retailer, and a wholesaler.

5. The system of claim 1, wherein the mapping comprises an Object Relational Mapping.

6. A method, comprising:
retrieving, by a process executing tenant access instructions, data related to a tenant associated with a user login and data related to tenants with a hierarchical relationship to the tenant; and
creating, by a processor executing the tenant access instructions, a mapping including the retrieved data,
wherein data is communicated via the mapping such that cloud application instructions are related to a single tenant application.

7. The method of claim 6, further comprising communicating, by a processor executing session instructions, determining tenant identifiers associated with user login information.

8. The method of claim 6, further comprising accessing, by a processor executing cloud application instructions, the mapping.

9. The method of claim 6, further comprising:
creating a tenant identifier associated with a user login, wherein the tenant identifier has a nested relationship with tenant identifiers associated other tenants with a hierarchical relationship with the tenant; and
wherein retrieving data related to the tenant comprises retrieving data based on the tenant identifier.

10. The method of claim 6, wherein the mapping comprises an Object Relational Mapping.

11. A machine-readable non-transitory storage medium comprising instructions executable by a processor to:
receive login information associated with a user session of a multi-tenant cloud application;
determine a set of identifiers associated with the user based on the login information, wherein the identifiers are related to the user and tenants related to the user in a hierarchical manner;
request from a data store data associated with the set of identifiers; and
create based on the requested data a mapping to be accessed to provide the cloud application to the user.

12. The machine-readable non-transitory storage medium of claim 11, instructions to determine the set of identifiers comprise instructions to determine the set of identifiers based on a range of identifier values.

13. The machine-readable non-transitory storage medium of claim 12, wherein instructions to request data from the data store comprise instructions to request data from the data store using an SQL BETWEEN operator for the range of identifiers.

14. The machine-readable non-transitory storage medium of claim 11, wherein instructions to create the mapping comprise instructions to create an Object Relational Mapping.

15. The machine-readable non-transitory storage medium of claim 11, wherein instructions to create the mapping comprise instructions to publish an interface to be used to retrieve the requested data without accessing the data store.
